(19) United States
(12) Patent Application Publication
(10) Pub. No.: US 2010/0096975 A1
(43) Pub. Date: Apr. 22, 2010

(54) PLASMA DISPLAY PANEL

(75) Inventors: Shin IMAMURA, Kokubunji (JP); Tatsuya MIYAKE, Tokorozawa (JP); Shunsuke MORI, Kokubunji (JP); Kazutaka TSUJI, Hachioji (JP); Keizo SUZUKI, Kodaira (JP); Toshiaki KUSUNOKI, Tokorozawa (JP); Mitsuharu IKEDA, Mito (JP); Shirun HO, Tokyo (JP)

Correspondence Address: MATTINGLY & MALUR, P.C., 1800 DIAGONAL ROAD, SUITE 370, ALEXANDRIA, VA, 22314, US

(73) Assignee: HITACHI CONSUMER ELECTRONICS CO., LTD., Tokyo (JP)

(21) Appl. No.: 12/578,696

(22) Filed: Oct. 14, 2009

(30) Foreign Application Priority Data
Oct. 17, 2008 (JP) 2008-268767

(51) Int. Cl. H01J 17/49

(52) U.S. Cl. 313/489

(57) ABSTRACT

In order to reduce the discharge delay time and increase the image quality in a display device such as a PDP using ultraviolet light emission produced by discharge, there is provided a display device including: a front panel and a rear panel disposed opposite to each other with discharge spaces formed therebetween, and a discharge gas being injected into the discharge spaces; at least a pair of electrodes for performing a display discharge; and phosphor layers emitting visible light by using ultraviolet light emission produced by discharge of the discharge gas. At least one of the compounds represented by the composition formulas Cs₍₁₋ₓ₎M1ₓAl0₂ (where M1 is the I group element, 0≦5x<1) and Cs₍₁₋ₓ₎M2ₓAl₍₁₊ₓ₎O₍₂₊₂ₓ₎ (where M2 is the II group element, 0≦x<1) is present in any of the components constituting the discharge spaces of the display device.

### CLAIM OF PRIORITY

The present application claims priority from Japanese Patent Application JP 2008-268767 filed on Oct. 17, 2008, the content of which is hereby incorporated by reference into this application.

The present invention relates to a display device, and more particularly to a plasma display panel formed by using phosphors emitting by being excited by ultraviolet radiation, in particular, vacuum ultraviolet radiation.

### BACKGROUND OF THE INVENTION

In recent years there has been an increased demand for reduction in thickness of display devices represented by TV and PC monitors requiring less installation space. Now, display devices available for reducing thickness are being actively developed, such as a plasma display panel (PDP) device, a field emission display device (FED), and a liquid crystal display device (LCD) which is a display device formed by combining a backlight and a thin liquid crystal panel.

The PDP device is a display device using a plasma display panel (PDP) as an emission device. The plasma display panel (PDP) uses, as an excitation source, ultraviolet radiation produced in the negative glow region in a micro discharge space including noble gas, which exists in the wavelength range of 146 nm and 172 nm when xenon is used as the noble gas. Light emission is produced in the visible region by exciting a phosphor in a phosphor layer provided in the micro discharge space by the excitation source, causing the phosphor to emit light. The PDP device controls the amount and color of the light emission to use for display.

The PDP device selects between light emission and no light emission in an image display of individual micro discharge spaces (hereinafter referred to as discharge cell) by adjusting the accumulation of wall charges in the discharge cell. The selection between light emission and no light emission is made by the wall charges producing a discharge called an address discharge, before light emission. For this reason, the proper generation of address discharge is very important in image display.

In the PDP device, the material necessary to be provided in the discharge space, such as phosphor material or barrier rib material, has an influence on the discharge characteristics described above. The material of phosphors or other material is a key component that is very important in determining the characteristics of the PDP device.

Such materials and technology are described, for example, in JP-A No. 306995/1998, JP-A No. 041251/2003, JP-A No. 183649/2003, and JP-A No. 239936/2005.

In recent years, the PDP device has been recognized in its high quality, replacing the monitors and TVs using a cathode-ray tube and now being increasingly used as large flat panel displays and thin TVs. As a result, further performance improvement is expected. More specifically, in order to display high definition digital broadcasts, it is necessary to increase the resolution to a higher level. Further, such a resolution enhancement can be achieved by reducing the size of each display pixel, so that it is necessary to increase the brightness. Additionally, in order to achieve the high brightness, it is necessary to increase the light emission efficiency.

Thus, the resolution enhancement means the increase in the number of discharge cells. In the PDP device, one display is produced by scanning rows of pixels, generating the address discharge described above, and determining pixels to emit light. In general, one TV image is formed in 1/60 seconds (one field). In the PDP device, one field is divided into about 10 subfields. Discharged are generated in each subfields. Thus, the time for address discharge in each discharge cell is very short. With the resolution enhancement, the number of rows of pixels to be scanned is further increased, so that the time for address discharge is further reduced. For this reason, it is difficult to properly perform address discharge in the resolution enhancement. When the address discharge is not performed properly, flicker or instability occurs in the display, resulting in degradation of the image quality.

Currently, in the PDP device technology, a study is being made on the improvement of the structure of the plasma display panel (PDP), for the resolution enhancement by increasing the discharge intensity in each discharge cell, as a high quality TV set.

As a method to address this improvement, an intensive study is being made on the use of Xe₂ emission generated by increasing the composition ratio of Xe gas in the discharge gas containing Ne as a main component. That is the so-called technology trend of “high density xenon” in the PDP panel, which in general aims to achieve high light emission efficiency of the PDP panel in the composition ratio range higher than the composition ratio of the xenon gas (about 4%) contained in the discharge gas.

However, the high density xenon often leads to an increase in discharge voltage. This increases the load on a driving circuit and the like, resulting in an increase in the cost of the device. Also, the time necessary to start the above described address discharge is increased, making it more difficult to properly perform the address discharge.

The PDP device is being increasingly used as flat TV sets replacing TV sets using a cathode-ray tube, much more than merely thin display devices. As a result, a higher image quality is demanded. Under these circumstances, it is important to achieve the improvement of the image quality by reducing flicker or other instability in the display, in addition to achieving the demand for brightness, low power consumption, and reduced cost. Thus, in order to improve the image quality, it is important to generate a proper discharge by reducing the time for the address discharge.

### SUMMARY OF THE INVENTION

The present invention aims to solve the above described problem and to provide a display device with high image quality and high efficiency.

A brief description will be given to the outline of the representative aspects of the present invention disclosed in the present application.

The above problem can be solved by a display device using ultraviolet light emission produced by discharge, in which a compound containing an element with a work function of 3.6 eV or less in the state of a metal is present in a discharge space in a portion other than a protective layer, electrode, glass, and dielectric layer. The compound containing the specific element has quantum efficiency of 15% or less with respect to the visible light emission in the range of 450 nm to 780 nm by the irradiation of ultraviolet light at a wavelength of 450 nm or less. Incidentally, the compound containing the element with the work function of 3.6 eV or less in the state of a metal is the same meaning as the compound containing the metal with the work function of 3.6 eV or less. It is more efficient when the work function of the compound is 2.5 eV or less, and the effect is significant with 2.2 eV or less.

Further, when the compound containing the specific element has quantum efficiency of 15% or less with respect to the visible light emission in the range of 450 nm to 780 nm by the irradiation of ultraviolet light at the wavelength of 450 nm or less, it is possible to ignore the influence on the visible light by the irradiation of ultraviolet light to the compound when mixed with phosphors. Further, when the compound containing the specific element does not produce the visible light emission in the range of 450 nm to 780 nm by the irradiation of ultraviolet light at the wavelength of 450 nm or less, the image quality is not degraded at all.

Further, the effect is particularly significant in a display device using ultraviolet light emission produced by discharge, in which a compound containing Cs element is present in a portion of a discharge space, other than the protective layer, electrode, glass, and dielectric layer. The compound containing the Cs element has quantum efficiency of 15% or less with respect to the visible light emission in the range of 450 nm to 780 nm by the irradiation of ultraviolet light at the wavelength of 450 nm or less. However, most types of the compound having the characteristics described above are instable, and there is a problem in introduction of the compound into the display device. In the present invention, with the compound containing Cs represented by the composition formula Cs₍₁₋₁₎M1ₓAl0₂ (where M1 is the I group element, 0≦x<1) or Cs₍₁₋ₓ₎M2ₓAl₍₁₊ₓ₎O₍₂₊₂ₓ₎ (where M2 is the II group element, 0≦x<1), the introduction is easy and it is particularly effective.

The compound can be introduced in a discharge space by being present in a phosphor layer for light emission display of visible light in the discharge space.

Further, the compound can be introduced in a discharge space by being placed at least in a portion of a barrier rib, front panel, and the like in the discharge space, except for a phosphor layer for light emission display of visible light in the discharge space.

Further, the compound can be introduced in a discharge space by being present as a thin film in a phosphor layer for light emission display of visible light in the discharge space. The thickness of the thin film is preferably 0.01 μg or more in weight per square centimeter. In other words, the effect can be obtained with the compound having a thickness of about 0.2 atomic layers.

The effect appears when the weight ratio of the compound in a discharge space is 0.01% or more and 10% or less with respect to the total weight of all the phosphors in the discharge space.

Further, the effect appears when the weight of the compound mixed in the phosphors or contained in the barrier ribs and the like in the discharge space is 0.1 mg or more and 1000 mg or less per 100 cm² of the panel area.

The effect is more significant when the above described display devices are plasma display devices including a gas containing Xe gas in an amount with the composition ratio of the discharge gas of 8% or more.

Further, the effect is more significant when the above described display devices are plasma display devices having 700 or more display pixel lines.

According to the present invention, since the discharge delay time can be reduced in the address period, it is possible to perform address discharge properly. This allows display resolution enhancement, realizing a display without flicker.

### BRIEF DESCRIPTION OF THE DRAWINGS

FIG. 1 is a graph showing the relationship between the mixing amount of Cs compound and the discharge delay time;

FIG. 2 is a graph showing the relationship between the quantum efficiency of the Cs compound and the CIE chromaticity parameter;

FIG. 3 is a graph showing the relationship between the amount of the Cs compound and the discharge delay time when the Cs compound is used as a material of barrier ribs;

FIG. 4 is a graph showing the relationship between the weight of the Cs element and the display delay time;

FIG. 5 is an exploded perspective view of a plasma display panel;

FIG. 6 is a cross-sectional view along line A-A of FIG. 5;

FIG. 7 is a cross-sectional view along line B-B of FIG. 5;

FIG. 8 is a cross-sectional view along line C-C of FIG. 5;

FIG. 9 is a diagram of operating voltage waveforms of the plasma display panel;

FIG. 10 is a cross-sectional view showing a second embodiment according to the present invention;

FIG. 11 is another cross-sectional view showing the second embodiment;

FIG. 12 is a cross-sectional view showing a third embodiment according to the present invention;

FIG. 13 is a cross-sectional view showing a fourth embodiment according to the present invention; and

FIG. 14 is a cross-sectional view showing a fifth embodiment according to the present invention.

### DETAILED DESCRIPTION OF THE PREFERRED EMBODIMENTS

Hereinafter, representative examples of the embodiment of the present invention will be described and effects thereof will be described. The present invention is also effective with configurations other than the configuration described below, as long as they achieve the same effect.

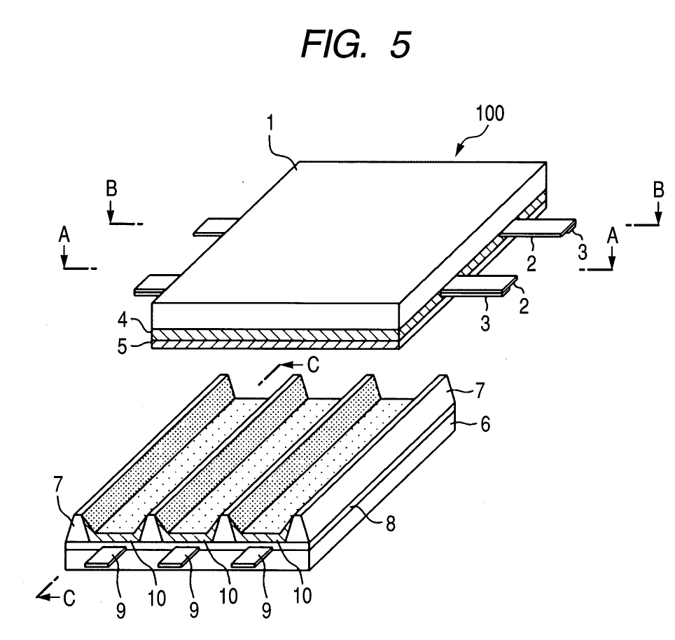

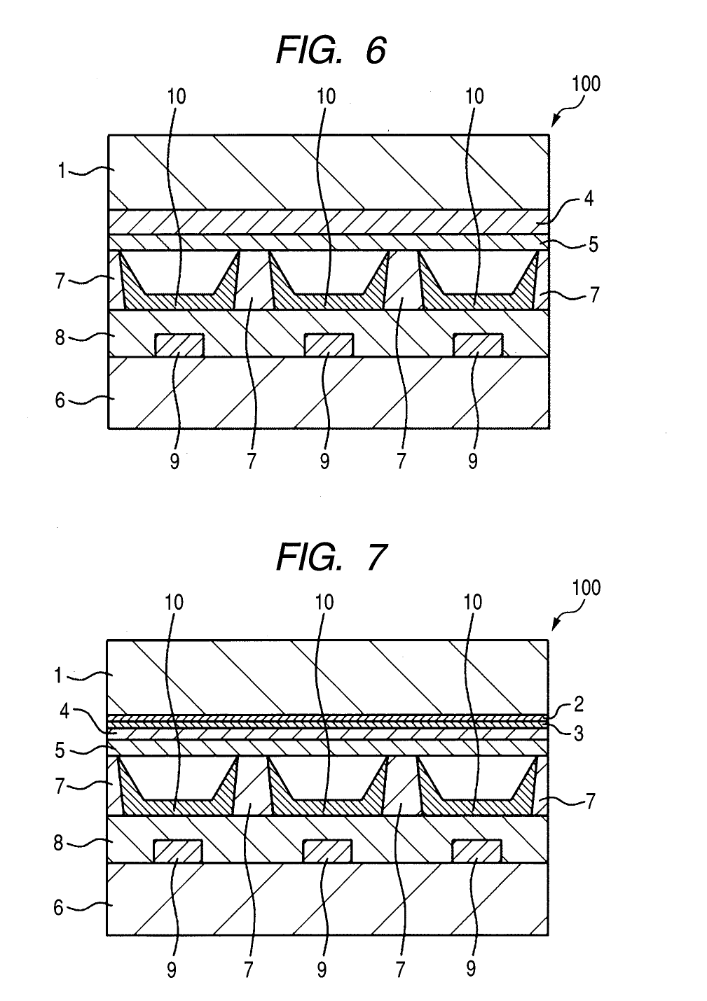

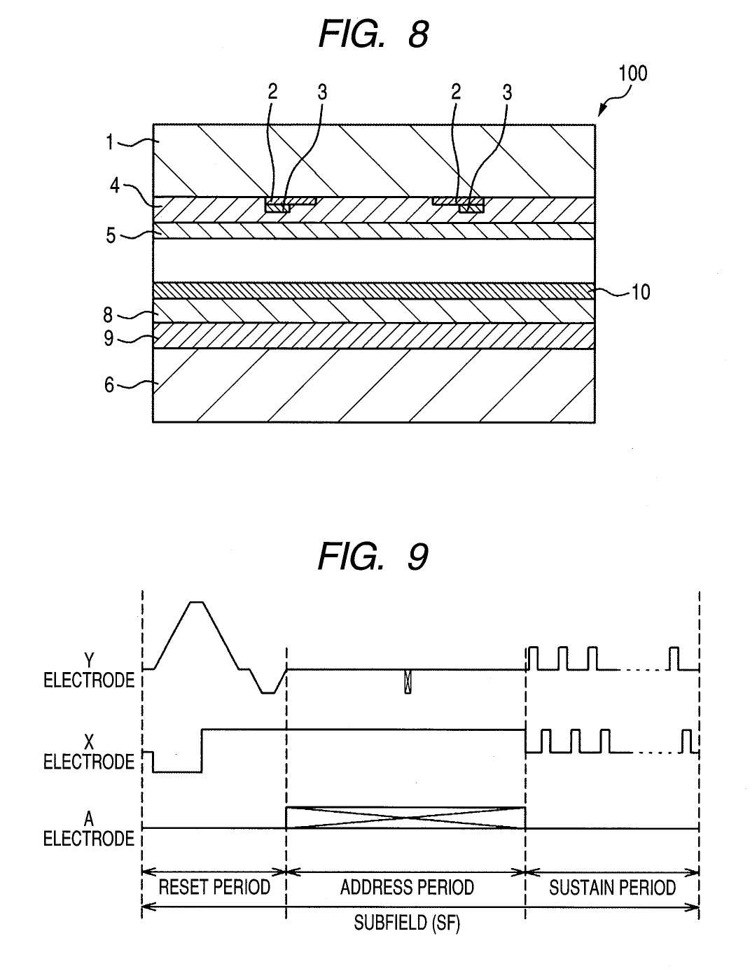

FIG. 5 is an exploded perspective view of an essential part of a PDP 100 according to the present invention. FIGS. 6, 7, and 8 are cross-sectional views, respectively, along lines A-A, B-B, and C-C of the assembled PDP 100 shown in FIG. 5. More specifically, FIG. 6 shows a cross section along the direction in which an electrode 2 extends. FIG. 7 shows another cross section along the direction in which the electrode 2 extends. FIG. 8 shows a cross section along the direction in which an electrode 9 extends.

The PDP 100, which is an embodiment of the present invention, has a structure for a so-called surface discharge PDP (reflective AC drive). The PDP 100 includes a pair of substrates 1, 6 facing apart from each other, barrier ribs 7 provided on the substrate 6 to keep the distance between the substrates 1 and 6 when the substrates 1 and 6 are combined with each other, a discharge gas (not shown) injected into spaces formed between the substrates 1 and 6 to produce ultraviolet radiation by discharge, and electrodes 2 and 9 respectively provided on the opposing surfaces of the substrates 1 and 6.

Then, phosphors for light emission display constitute phosphor layers 10 over the substrate 6 of the pair of substrates, as well as on surfaces of the barrier ribs 7. The phosphors constituting the phosphor layers 10 emit visible light by being excited by vacuum ultraviolet radiation at wavelengths of 146 nm and 172 nm, which is produced from the discharge gas by discharge. Here, a discharge space is an area surrounded by the dielectric layer 8, the barrier ribs 7, and the protective layer 5 in FIG. 6.

Incidentally, in FIGS. 5, 7, and 8, reference numeral 3 denotes a bus line of silver or Cu—Cr provided together with the electrode 2 to reduce the resistance of the electrode. Reference numerals 4 and 8 denote dielectric layers. Reference numeral 5 denotes a protective layer for protecting the electrodes. For example in FIG. 5, the barrier ribs are arranged in a linear manner, but may also have a rectangular configuration separating the discharge cells from each other.

Each of the phosphor layers 10 is separately provided with three-color phosphors of red, green, and blue so as to perform a color display. Examples of the phosphors emitting each of the three colors are as follows: red emitting (Y,Gd)BO₃:Eu phosphors, green emitting Zn₂SiO₄:Mn²⁺ phosphors, and blue emitting BAM (BaMgAl₁₀O₁₇:Eu²⁺) phosphors. These phosphors are often used as the main components of the respective colors, but other materials can also be used. Although phosphors having an average particle diameter of 1 to 5 μm are often used, it is also possible to use phosphors having other particle diameters.

FIG. 9 shows an example of the voltage applied to each electrode. Y and X electrodes are the neighboring electrodes 2 in FIG. 5. Light emission display is performed by a discharge (sustain discharge) between the two electrodes. The voltage for sustain discharge is applied simultaneously in all discharge cells. Thus, it is necessary to select the discharge cells allowed to discharge and emit light, and the discharge cells not allowed to emit light. The selection is made by producing a discharge between A and Y electrodes. The A electrode corresponds to the electrode 9 in FIG. 5.

In order to select the discharge cell to be allowed to emit light, a voltage is simultaneously applied to the A electrode as well as the Y electrodes perpendicular to the A electrode. A discharge (address discharge) occurs between the A and Y electrodes only in the discharge cell to which the voltage is applied simultaneously. At this time, charges are accumulated in the discharge cell. The voltage between the Y and X electrodes is set to a value not allowing the discharge to be started. The discharge is started only when the voltage of the accumulated charges is added to the voltage between the Y and X electrodes. Thus, only the discharge cell having generated the address discharge can emit light by discharge, and an image can be formed.

Further, the sustain discharge continuously occurs in the discharge cell after the formation of the wall charges. In order to prevent the discharge cell from emitting light, it is necessary to eliminate the wall charges. For this reason, before the application of the voltage for address discharge, a voltage is applied in order to eliminate the wall charges in all the discharge cells. This voltage is a reset voltage, and the time for applying the reset voltage is a reset period.

FIG. 9 shows voltage application sequences in a period called a subfield. One image is formed in a period called one field. In order to differentiate the brightness of each pixel, one field is divided into approximately 10 subfields. Then, a series of discharges is made in each subfield.

An address discharge is generated by scanning each row of pixels one by one. When the resolution is increased and the number of pixels is increased, the number of rows of pixels to be scanned is increased. As a result, the time for one address discharge is reduced.

In the discharge cell, a discharge is generated as follows. When a voltage is applied between the electrodes, charged particles, which exist in a small amount in the discharge space, move closer to the electric field. Then, the charged particles collide against the discharge gas, generating further charged particles. This process is repeated, and then the discharge is started. The charged particles existing in a small amount in the discharge space are called priming particles.

The existing amount of priming particles at the time of voltage application is a factor to determine the time for generating an address discharge. A discharge is started when charged particles necessary for the start of the discharge are formed after the voltage is applied. The time necessary for the start of the discharge is called discharge delay time. When the number of priming particles is small, it takes a lot of time to form charged particles necessary for the start of the discharge, resulting in an increase in the discharge delay time. In order to reduce the address discharge time, it is necessary to reduce the discharge delay time. The increase in the number of existing priming particles is a way to reduce the discharge delay time, namely, the address discharge time.

The priming particles are formed by sustain discharge. The number of the priming particles decreases as the time passes from the sustain discharge. For this reason, the time interval between the end of the sustain discharge and the start of the address discharge is important. Examples of the time interval are about 0.2 ms in the first line of a pixel row to be scanned for address discharge, and about 1.2 ms in the last line.

In a configuration of the present invention, it is desirable to reduce the time necessary for an address discharge to perform the address discharge properly. The time necessary for the address discharge is called the discharge delay time. With the composition according to the present invention, it is possible to increase the number of existing priming particles at the time of the address discharge. As a result, the time necessary for the address discharge is reduced, so that the delay time of the address discharge is reduced.

Priming particles are emitted from the protective layer or other layers in the discharge cell. The discharge greatly varies depending on the condition of a surface of the specific layer. A certain substance is attached to the surface in order to facilitate the emission of the priming particles from the surface of the specific layer. As a result, the number of priming particles can be increased.

The present inventors have found that when an element with a work function of a certain value or less in the state of a metal is present on a surface of a portion emitting priming particles such as the protective layer, the number of priming particles increases and the address discharge delay time is reduced.

The reference work function of a certain value or less is represented by an approximate value of the work function of 3.7 eV of Mg that is the main component of the protective layer. The above effect can be obtained with a metal element having a work function smaller than the reference value, namely, a work function of 3.6 eV or less.

A more desirable reference values would be the work functions of 2.5 eV or less of elements represented by Ba and the like in alkali and alkaline earth metals. These elements are more effective in use. Further, in particular, the above effect is significant with an element having a work function of 2.2 eV or less such as Cs.

In general, however, most of the elements, which have work functions equal to or less than the predetermined value and show the characteristics described above, have high reactivity with oxygen and moisture. Thus, it is difficult to provide such elements on the surface of the specific layer to assemble a display device. Further, even if the elements are directly attached to the surface of the specific layer, the elements are gradually removed from the surface by plasma discharge. The characteristics are reduced during use, and the effect is not sufficient. Meanwhile there is still the following effect. That is, when a plasma display panel is completed as a product, the plasma display panel is actually lit and subject to aging. In the aging, the time for starting discharge is reduced by the effect of a material 12 according to the present invention, allowing the aging time to be reduced.

In the present invention, the following method is performed to obtain sufficient effect. That is, a compound of the elements is also provided, for example, in a portion other than the surface of the protective layer generally to be involved in the emission of priming particles. These elements are attached to the surface of the portion emitting priming particles due to heating in production processes and plasma discharges, facilitating the emission of priming particles. This effect can be continued even if the surface of the portion emitting priming particles is removed by plasma discharge, because the priming particles are supplied by the compound of the elements provided in another portion. An example of the portion other than the protective layer is the top or sides of the barrier ribs.

Further, the introduced elements may allow for directly emitting priming particles from the initially set position, or allow for facilitating the emission of priming particles. The priming particles given by the effects are effective in increasing the number of priming particles for address discharge. However, when the elements are provided in the electrodes, the dielectric layer, the inside of the glass or the like, a sufficient effect is not obtained. In the present invention, it has been found that it is particularly effective with at least one of the two types of compounds represented by composition formulas Cs₍₁₋ₓ₎M1ₓAl0₂ (where M1 is the I group element, 0≦x<1) and Cs₍₁₋ₓ₎M2ₓAl₍₁₊ₓ₎O₂₊₂ₓ₎ (where M2 is the II group element, 0≦x<1).

Further, when the introduced compounds emit visible light, unnecessary light is added to and has an influence on the light emitting display image. This leads to a reduction in the color reproduction as well as a change in the brightness life, making the product design difficult. For this reason, it is necessary to control the amount of the compounds so that the visible light emission does not affect the image. As an example, FIG. 2 shows the case in which a blue emitting material is mixed in green emitting phosphors to change the emission efficiency of the blue emitting material. The measurement was performed using a luminance meter that could measure CIE chromaticity parameters. Then, the obtained CIE chromaticity parameters y were compared. It can be seen that the chromaticity parameter y of the ordinate decreases as the quantum efficiency of the mixed material according to the present invention is increased. This shows that when the quantum efficiency is increased, the amount of blue-violet emission is increased, which has the influence on the green emission color.

In the light emission of the green phosphors, when the chromaticity parameter y exceeds 0.7, the green color reproduction is good. When the chromaticity parameter y is lower, the green color reproduction is poorer. The chromaticity parameter y is preferably equal to or more than 0.7 for the plasma display. From FIG. 2, it can be seen that when the quantum efficiency is about 15% or less, the chromaticity parameter y is equal to or more than 0.7, so that good color reproduction can be maintained. Thus, it is preferable that the material according to the present invention has quantum efficiency of light emission equal to or less than 15%.

In other words, it is preferable that the compound according to the present invention does not produce visible light emission by ultraviolet radiation. Even with light emission, the quantum efficiency should be limited to 15% or less with respect to the visible light emission in the range of 450 nm to 780 nm by irradiation of ultraviolet light at a wavelength of 450 nm or less. Here, the external quantum efficiency is a value indicating the ratio of the number of photons emitted to the outside when the compound emits light to the number of photons incident on the compound. The external quantum efficiency can be measured by a commercially available measuring device and the like.

Further, in the above described configuration according to the present invention, the introduction of the compound is possible by being present in a phosphor layer for light emission display of visible light in a discharge space, by way of mixing or lamination. Further, in another configuration according to the present invention, the introduction of the compound is also possible by being placed, for example, in a portion of the barrier ribs or the front panel in a discharge space other than the protective layer, the electrodes, the dielectric layer, and the inside of the glass, except for the phosphor layer for performing visible light emission in the discharge space. Here, for example, when the compound is mixed in the protective layer, it may have an adverse effect on the life of the protective layer.

For the reasons described above, the present invention is particularly effective in the use of the plasma display device having gas containing Xe gas in an amount that the composition ratio of the discharge gas is 8% or more. Further, for the reasons described above, the present invention is particularly effective in the use of the plasma display device having 700 or more display pixels lines.

Preferred embodiments of the present invention will be described below.

### First Embodiment

A PDP of an embodiment according to the present invention was produced. Phosphors emitting three colors of red, green, and blue were prepared with the following materials: (Y,Gd)BO₃:Eu as the main component of red phosphors, Zn₂SiO₄:Mn²⁺ as the main component of green phosphors, and BAM(BaMgAl₁₀O₁₇:Eu²⁺) as the main component of blue phosphors. However, the effect of the present invention is also effective when other materials are used as the main components of the respective phosphors of three colors.

A display device according to the present invention was produced by mixing a predetermined amount of compound containing an element satisfying the conditions of the present invention, with respect to each of the phosphors of three colors. Examples of the compound satisfying the conditions include compounds represented by the following composition formulas: Cs₍₁₋ₓ)M1ₓAl0₂ (where M1 is the I group element, 0≦x<1) and Cs₍₁₋ₓ₎M2ₓAl₍₁₊ₓ₎O₍₂₊₂ₓ₎ (where M2 is the II group element, 0≦x<1). At least one of these components was mixed, for example, in a form of powder with an average particle diameter of 0.1 μm or more and 50 μm or less and in an amount of from 0.01 wt % to 10 wt %. In this way, a PDP 100 shown in FIG. 5 was produced as the display device according to the present invention. The compounds to be mixed are not limited to the above examples, and other compounds are also effective as long as they satisfy the conditions of the present invention. Incidentally, when the compound is prepared as a form of powder with the average particle diameter of 0.1 μm or more and 50 μm or less, it is easy to mix the compound with the phosphors and easy to form a film by printing.

In the PDP 100 of a surface-discharge type color PDP device as described in this embodiment, for example, a discharge is generated by applying a negative voltage to one electrode (generally called a scan electrode) of a pair of display electrodes (electrodes 2), and by applying a positive voltage (positive voltage with respect to the voltage applied to the display electrode) to an address electrode (electrode 9) and to the other remaining display electrode (electrode 2). Then, wall charges are formed and help start the discharge between the pair of display electrodes (which is referred to as writing). In this state, when an appropriate reverse voltage is applied between the pair of display electrodes, the discharge is generated in the discharge space between the display electrodes 2 via the dielectric layer 4 (and the protective layer 5).

Upon completion of the discharge, when the reverse voltage is applied to the pair of display electrodes (electrodes 2), another discharge is generated. This process is repeated to intermittently generate discharges (which is referred to as sustain discharge or display discharge).

In the PDP 100 of the present embodiment, the address electrodes (electrodes 9) of silver or other metal, and the dielectric layer 8 of a glass-based material are formed on a rear substrate (substrate 6). Then, a barrier rib material, which is also of a glass-based material, is thick film printed on the dielectric layer. Then, barrier ribs 7 are formed by blast removal using a blast mask.

Next, the phosphor layers 10 of red, green, and blue colors are sequentially formed on the barrier ribs 7 in a stripe shape so that the phosphor layers 10 are coated over the groove surfaces between the barrier ribs 7. Here, the phosphor layers 10 corresponding to red, green, and blue colors, are formed as follows: 40% by weight of a mixture of the compound and red phosphor particles (60% by weight of vehicle), 40% by weight of a mixture of the compound and green phosphor particles (60% by weight of vehicle), and 35% by weight of a mixture of the compound and blue phosphor particles (65% by weight of vehicle), are mixed with the vehicle to prepare phosphor paste of three colors. The phosphor paste is applied by screen printing. Then, a volatile component in the phosphor paste is evaporated by a dry process, and an organic material in the phosphor paste is burned and removed by a burning process. The phosphor layers 10 used in the present embodiment include phosphor particles with a median diameter of about 3 μm.

Next, a front substrate (substrate 1) in which the display electrodes (electrodes 2), the bus lines 3, the dielectric layer 4, and the protective layer 5 are formed, and the rear substrate (substrate 6) are frit-sealed together. The panel is exhausted to vacuum and sealed by injecting discharge gas therein. The discharge gas contains xenon (Xe) gas in an amount that the composition ratio of the discharge gas is 10%.

Next, using the PDP of the embodiment according to the present invention, a plasma display panel device was produced as a display device designed to perform image display in combination with a driving circuit for driving the PDP. This plasma display panel device has high brightness and high display performance, thereby allowing for a high brightness display. Also, it allows for a high-speed address discharge, thereby allowing for a fine and high quality image display.

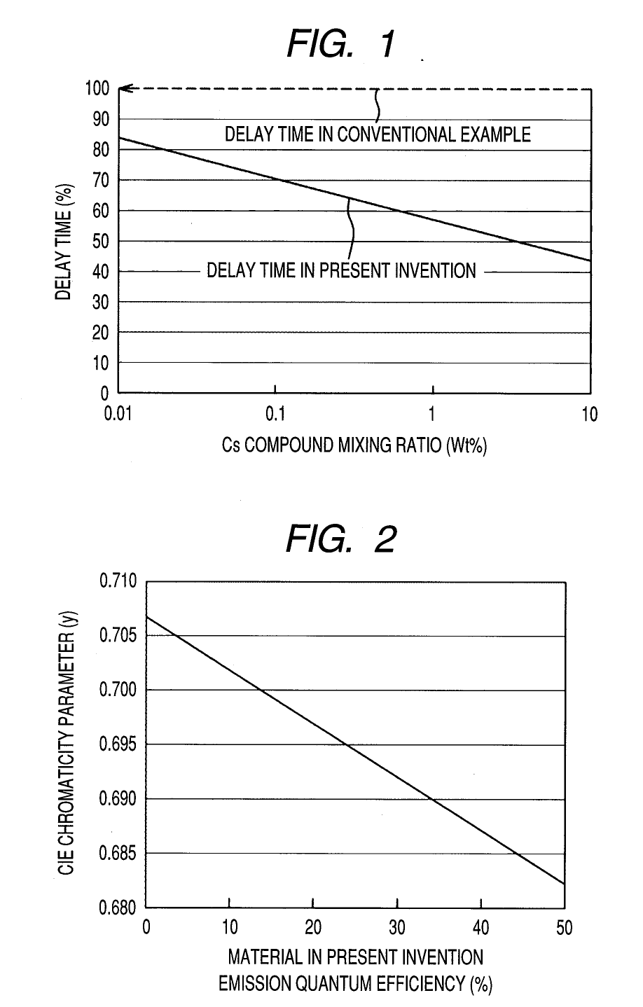

FIG. 1 shows the relationship between the discharge delay time of the display device according to the present invention, and the phosphor mixing amount that satisfies the conditions of the present invention. In FIG. 1, the abscissa represents the ratio of the mixing amount of the compound according to the present invention, with respect to the light emitting phosphors. The ordinate represents the time necessary for an address discharge, namely, the discharge delay time. With respect to the light emitting phosphors, the experiments were performed for each of the red, green, and blue phosphors, in which all the phosphors showed the same tendency. FIG. 1 is a graph of the average values of the experiments performed for each of the red, green, and blue phosphors. Further, the delay times were measured under the operation condition that the time interval between the sustain period and the address period is 10 ms in FIG. 9. In other wards, the discharge delay time is about 57% with 1% by weight of the compound in the mixture. The discharge delay time is about 44% with 10% by weight of the compound in the mixture. As described above, the reduction of the discharge delay time according to the present invention is very effective.

According to the present invention, even in the highly fine display device having 700 or more pixel display lines, it is possible to achieve a high quality image display without flicker or other image quality degradation. Further, in the plasma display, it is seen that the address discharge time tends to be increased when the Xe concentration is 8% or more. However, with the present invention, it is possible to achieve a high quality image display without flicker or other image quality degradation, even if the Xe concentration is 8% or more.

From FIG. 1, it can be found that a very small mixing amount is effective in obtaining good characteristics. In other words, the discharge delay time is reduced by 18% when the compound according to the present invention is included in only a small amount of 0.1% by weight. On the other hand, when the mixing amount of the compound exceeds 50% by weight, the emission intensity for the image display is significantly reduced and this is not desirable. Taking into account the brightness of the display device, it is desirable that the mixing amount of the compound is set to about 0.01% to 10% by weight.

The weight of the phosphors per 100 cm² of the panel area is about 500 mg. Thus, it is desirable that the weight of the compound per 100 cm² of the panel area is in the range of 0.1 mg to 50 mg.

Further, it is also possible to produce the PDP by using red, green, and blue phosphors of the following compositions. That is, it is possible to include one or more red phosphors selected from a group of (Y,Gd)BO₃:Eu, (Y,Gd)₂O₃:Eu, and (Y,Gd)(P,V)O₄:Eu, one or more green phosphors selected from a group of YBO₃:Tb, (Y,Gd)BO₃:Tb, BaMgAl₁₄O₂₃:Mn, and BaAl₁₂O₁₉:Mn, and one or more blue phosphors selected from a group of CaMgSi₂O₆:Eu, Ca₃MgSi₂O₈:Eu, Ba₃MgSi₂O₈:Eu, and Sr₃MgSi₂O₈:Eu.

The above phosphors are examples of the phosphors that are commonly used. The effect of the present invention is effective regardless of the type of phosphor to be used. Phosphors other than the above ones can also be used to produce the display device according to the present invention.

Although the invention made by the present inventors has been described in detail with reference to the preferred embodiment and examples thereof, it will be appreciated that the present invention is not limited to the embodiment described hereinbefore and various modifications and changes may be made thereto without departing from the spirit and scope of the invention.

### Second Embodiment

A PDP of a second embodiment according to the present invention was produced. The basic structure, phosphor materials, and production method are the same as those in the first embodiment. The second embodiment is different from the first embodiment in that the compound 12 containing the element satisfying the conditions of the present invention is not mixed in each of the red, green, and blue phosphors for performing image display. In this embodiment, a display device according to the present invention was produced by forming a predetermined amount of the compound 12 according to the present invention in at least a portion of a surface of the dielectric layer 8, the top and side surfaces of the barrier ribs 7.

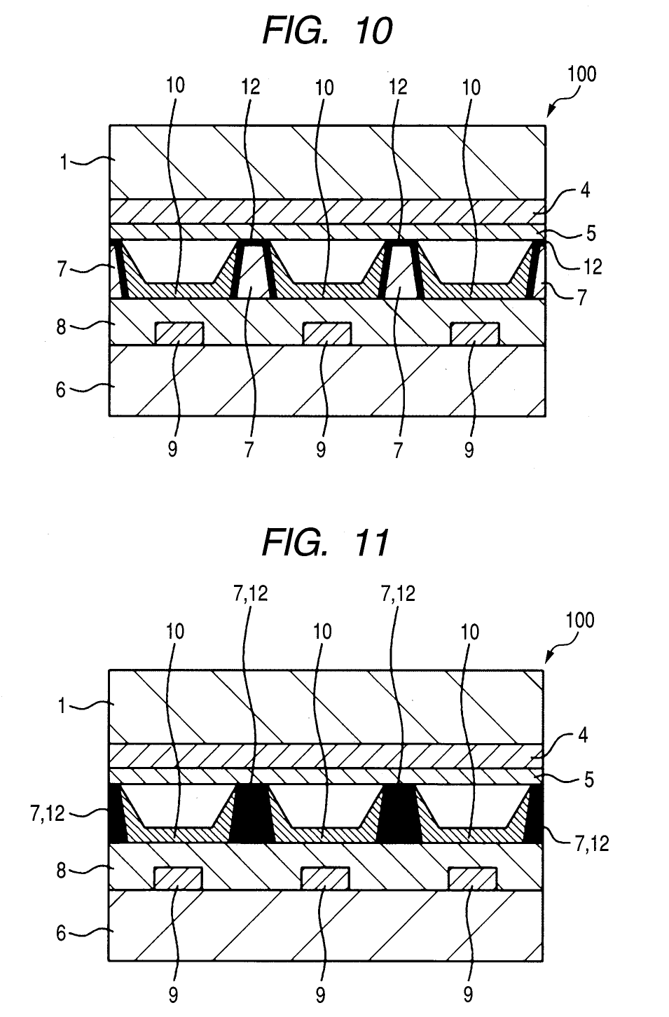

A specific example of the production method is as follows. That is, as shown in FIG. 10, before the formation of the phosphor layers 10, a layer of a predetermined amount of the material 12 according to the present invention is formed in the top and side surfaces of the barrier ribs 7. Then, the phosphor layers 10 are formed thereon. Further, as shown in FIG. 11, the barrier rib itself can be formed by the material 12 according to the present invention. The display device of the second embodiment showed good characteristics similarly to those in the first embodiment.

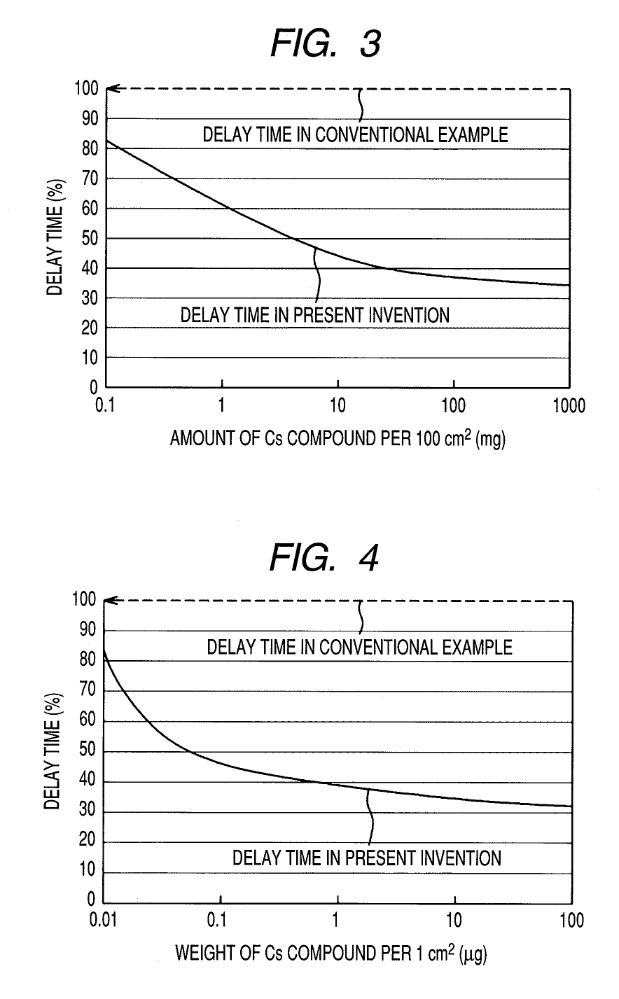

FIG. 3 shows the relationship between the existing amount of the compound according to the present invention per 100 cm² of the panel area, and the discharge delay time, when the compound according to the present invention is used for the material of the barrier ribs or applied to the barrier ribs. As seen from FIG. 3, the discharge start voltage is significantly reduced until the existing amount of the compound according to the present invention reaches 10 mg per 100 cm². As the amount of the compound according to the present invention is further increased, the discharge start voltage is further reduced. In FIG. 3, the effect is maintained until 1000 mg.

The material 12 according to the present invention can also be used as a structure like the glass. FIG. 11 shows a case in which the barrier ribs themselves are formed by the material 12 according to the present invention. The process of forming the barrier ribs by the material 12 according to the present invention is the same as the process of forming the barrier ribs by a conventional material. More specifically, the material 12 according to the present invention is applied to the dielectric layer by printing, which is then sintered. Then the surface of the sintered film is sand-blasted using a blast mask to form concave portions. When the material 12 according to the present invention is used for the structure, the relationship between the discharge delay time and the existing amount of the material 12 according to the present invention, as shown in FIG. 3, is similar to that in the case in which the material 12 according to the present invention is applied to the barrier ribs.

### Third Embodiment

A PDP of a third embodiment according to the present invention was produced. The basic structure, phosphor material, and production method are the same as those in the first embodiment.

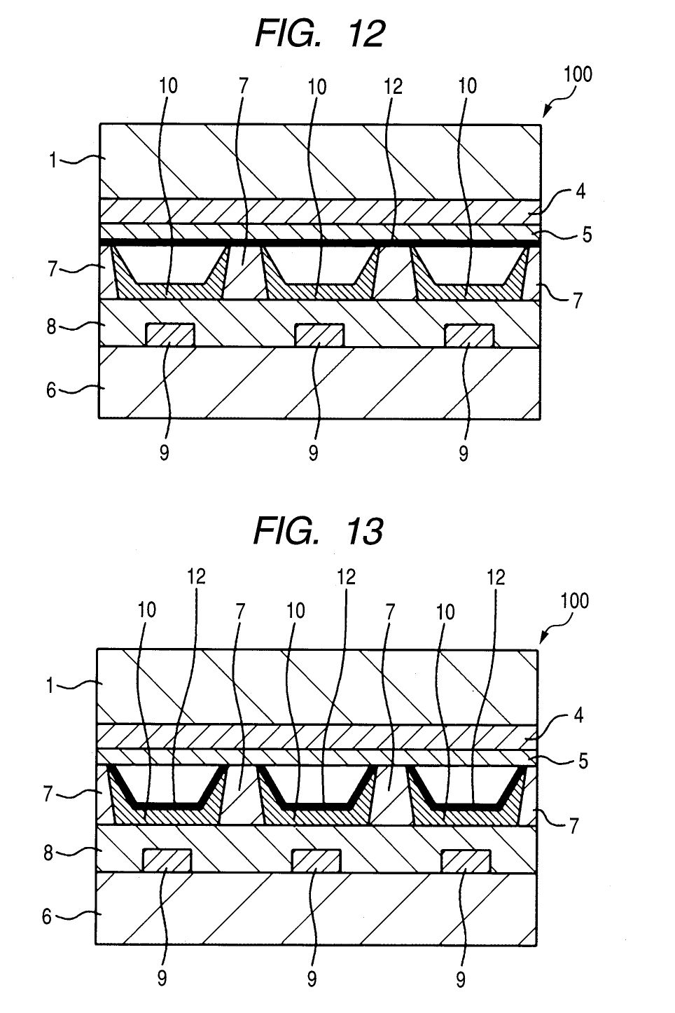

The third embodiment is different from the first embodiment in that the compound 12 containing the element satisfying the conditions of the present invention is not mixed in each of the red, green, and blue phosphors for performing image display. As shown in FIG. 12, a display device according to the present invention was produced by forming the compound 12 according to the present invention as a thin film at least in a portion on the side of the substrate 1, namely, on a surface of the protective layer. FIG. 12 is a schematic cross-sectional view of a case in which the material 12 according to the present invention is applied to the surface of the protective layer of the substrate 1 by evaporation or sputtering.

FIG. 4 is a graph showing the effect of reducing the discharge delay time when the material 12 according to the present invention is formed as a thin film on the surfaces of the phosphors, the surface of the protective layer or the like. As seen from FIG. 4, the effect appears when the weight of the Cs element according to the present invention is 0.01 μg per 1 cm². The discharge delay time is rapidly reduced until 1 μg, and then the discharge delay time is still reduced. The weight of the Cs element can be measured by analysis means such as Zeeman atomic absorption spectrometer (ZAAS) and X-ray fluorescence spectrometer (XRF). The display device of the third embodiment showed good characteristics similarly to those in the first embodiment.

### Fourth Embodiment

A PDP of a forth embodiment according to the present invention was produced. The basic structure, phosphor material, and production method are the same as those in the first embodiment. The fourth embodiment is different from the first embodiment in that the compound 12 containing the element satisfying the conditions of the present invention is not mixed in each of the red, green, and blue phosphors for image display. As shown in FIG. 13, the display device according to the present invention was produced by forming the material 12 according to the present invention as a thin film on surfaces of the phosphors provided on the side of the substrate 6. A specific example of the production method is that, after the formation of the phosphor layers 10, the material 12 according to the present invention is formed on the surfaces of the phosphors by evaporation or sputtering.

The characteristics were examined by changing the amount of the thin film formed on the surfaces of the phosphors. The results are the same as the results in the third embodiment, as shown in FIG. 4. The display device of the fourth embodiment has good characteristics similarly to those in the first embodiment.

### Fifth Embodiment

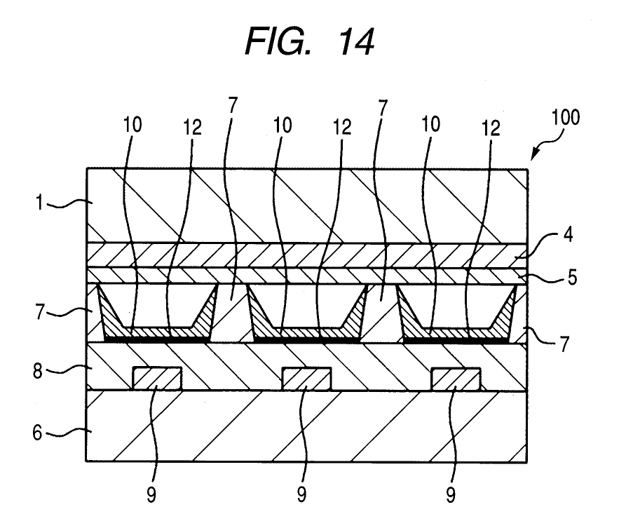

A PDP of a fifth embodiment according to the present invention was produced. The basic structure, phosphor material, and production method are the same as those in the first embodiment. The fifth embodiment is different from the first embodiment in that the compound 12 containing the element satisfying the conditions of the present invention is not mixed in each of the red, green, and blue phosphors for image display. As shown in FIG. 14, the compound 12 according to the present invention is formed as a thin film on a surface of the dielectric layer 8 on the side of the substrate 6.

More specifically, after the formation of the barrier ribs and before the application of phosphors by printing, the material 12 according to the present invention is applied to the surface in which the dielectric layer 8 is formed on the side of the rear substrate 6.

The characteristics were examined by changing the amount of the thin film formed on the surface of the dielectric layer 8. The results are the same as the results in the third embodiment, as shown in FIG. 4. In this case also, the weight of Cs can be measured by analysis means such as Zeeman atomic absorption spectrometer (ZAAS) and X-ray fluorescence spectrometer (XRF). The display device of the fifth embodiment showed good characteristics similarly to those in the first embodiment.

In summarizing the above explained embodiments, the following structures are also specific features of the present invention.

### Specific Feature 1:

A plasma display panel comprising:

a front panel in which X electrodes and Y electrodes are formed opposite to each other, a first dielectric layer is formed covering the X and Y electrodes, and a protective layer is formed covering the first dielectric layer;

a rear panel in which address electrodes are formed in a direction perpendicular to the X and Y electrodes, a second dielectric layer is formed covering the address electrodes, barrier ribs are formed on the second dielectric layer so that each of the address electrodes is disposed between the barrier ribs, and phosphors are formed in areas formed by the barrier ribs and the second dielectric layer; and

discharge spaces formed by the protective layer, the phosphors, and the barrier ribs by combining the front panel with the rear panel,

wherein the barrier rib is formed by a compound represented by the composition formula Cs₍₁₋ₓ₎M1ₓAl0₂ (where M1 is the I group element, 0≦x<1) or by a compound represented by the composition formula Cs₍₁₋ₓ₎M2ₓAl₍₁₊ₓ₎O₍₂₊₂ₓ₎ (where M2 is the II group element, 0≦x<1).

### Specific Feature 2:

The plasma display panel according to claim 13, wherein the weight of the compound represented by the composition formula Cs₍₁₋ₓ₎M1ₓAl0₂ (where M1 is the I group element, 0≦x<1) or the compound represented by the composition formula Cs₍₁₋ₓ₎M2ₓAl₍₁₊ₓ₎O₍₂₊₂ₓ₎ (where M2 is the II group element, 0≦x<1), which constitutes the barrier rib, is 0.1 mg or more and 1000 mg or less per 100 cm² of the panel area.

### Specific Feature 3:

A plasma display panel comprising:

a front panel in which X electrodes and Y electrodes are formed opposite to each other, a first dielectric layer is formed covering the X and Y electrodes, and a protective layer is formed covering the first dielectric layer;

a rear panel in which address electrodes are formed in a direction perpendicular to the X and Y electrodes, a second dielectric layer is formed covering the address electrodes, barrier ribs are formed on the second dielectric layer so that each of the address electrodes is disposed between the barrier ribs, and phosphors are formed in areas formed by the barrier ribs and the second dielectric layer; and

discharge spaces formed by the protective layer, the phosphors, and the barrier ribs by combining the front panel with the rear panel,

wherein a compound represented by the composition formula Cs₍ₗ₋ₓ₎M1ₓAl0₂ (where M1 is the I group element, 0≦x<1) or a compound represented by the composition formula Cs₍₁₋ₓ₎M2ₓAl₍₁₊ₓ₎O₍₂₊₂ₓ₎ (where M2 is the II group element, 0≦x<1) is formed as a thin film on a surface of the protective layer, and

an amount of Cs in the thin film is 0.01 μm or more per 1 cm².

### Specific Feature 4:

A plasma display panel comprising:

a front panel in which X electrodes and Y electrodes are formed opposite to each other, a first dielectric layer is formed covering the X and Y electrodes, and a protective layer is formed covering the first dielectric layer;

a rear panel in which address electrodes are formed in a direction perpendicular to the X and Y electrodes, a second dielectric layer is formed covering the address electrodes, barrier ribs are formed on the second dielectric layer so that each of the address electrodes is disposed between the barrier ribs, and phosphors are formed in areas formed by the barrier ribs and the second dielectric layer; and

discharge spaces formed by the protective layer, the phosphors, and the barrier ribs by combining the front panel with the rear panel,

wherein a compound represented by the composition formula Cs₍₁₋ₓ₎M1ₓAl0₂ (where M1 is the I group element, 0≦x<1) or a compound represented by the composition formula Cs₍₁₋ₓ₎M2ₓAl₍₁₊ₓ₎O₍₂₊₂ₓ₎ (where M2 is the II group element, 0≦x<1) is formed as a thin film on surfaces of the phosphors, and

an amount of Cs in the thin film is 0.01 μm or more per 1 cm².

### Specific Feature 5:

A plasma display panel comprising:

a front panel in which X electrodes and Y electrodes are formed opposite to each other, a first dielectric layer is formed covering the X and Y electrodes, and a protective layer is formed covering the first dielectric layer;

a rear panel in which address electrodes are formed in a direction perpendicular to the X and Y electrodes, a second dielectric layer is formed covering the address electrodes, barrier ribs are formed on the second dielectric layer so that each of the address electrodes is disposed between the barrier ribs, and phosphors are formed in areas formed by the barrier ribs and the second dielectric layer; and

discharge spaces formed by the protective layer, the phosphors, and the barrier ribs by combining the front panel with the rear panel,

wherein a compound represented by the composition formula Cs₍₁₋ₓ₎M1ₓAl0₂ (where M1 is the I group element, 0≦x<1) or a compound represented by the composition formula Cs₍₁₋ₓ₎M2ₓAl₍₁₊ₓ₎O₍₂₊₂ₓ₎ (where M2 is the II group element, 0≦x<1) is formed as a thin film on a surface of the second dielectric layer, and

the amount of Cs in the thin film is 0.01 μm or more per 1 cm².

What is claimed is:

1. A plasma display panel comprising:
a front panel in which X electrodes and Y electrodes are formed opposite to each other, a first dielectric layer is formed covering the X and Y electrodes, and a protective layer is formed covering the first dielectric layer;
a rear panel in which address electrodes are formed in a direction perpendicular to the X and Y electrodes, a second dielectric layer is formed covering the address electrodes, barrier ribs are formed on the second dielectric layer so that each of the address electrodes is disposed between the barrier ribs, and phosphors are formed in areas formed by the barrier ribs and the second dielectric layer; and
discharge spaces formed by the protective layer, the phosphors, and the barrier ribs, by combining the front panel with the rear panel,
wherein at least one of compounds represented by composition formulas Cs₍₁₋ₓ₎M1ₓAl0₂ (where M1 is the I group element, 0≦x<1) and Cs₍₁₋ₓ₎M2ₓAl₍₁₊ₓ₎O₍₂₊₂ₓ₎ (where M2 is the II group element, 0≦x<1), is present in any of the protective layer, the barrier ribs, the phosphors, and the second dielectric layer.

2. The plasma display panel according to claim 1, wherein the light emission efficiency of the compound is 15% or less with respect to visible light in the range of 450 nm to 780 nm by the irradiation of ultraviolet light at a wavelength of 450 nm or less.

3. The plasma display panel according to claim 1, wherein M1 of the compound is a K element.

4. The plasma display panel according to claim 1, wherein M2 of the compound is a Ca element.

5. A plasma display panel comprising:
a front panel in which X electrodes and Y electrodes are formed opposite to each other, a first dielectric layer is formed covering the X and Y electrodes, and a protective layer is formed covering the first dielectric layer;
a rear panel in which address electrodes are formed in a direction perpendicular to the X and Y electrodes, a second dielectric layer is formed covering the address electrodes, barrier ribs are formed on the second dielectric layer so that each of the address electrodes is disposed between the barrier ribs, and phosphors are formed in areas formed by the barrier ribs and the second dielectric layer; and
discharge spaces formed by the protective layer, the phosphors, and the barrier ribs by combining the front panel with the rear panel,
wherein at least one of compounds represented by composition formulas Cs₍₁₋ₓ₎M1Al0₂ (where M1 is the I group element, 0≦x<1) and Cs₍₁₋ₓ₎M2ₓAl₍₁₊ₓ₎O₍₂₊₂ₓ₎ (where M2 is the II group element, 0≦x<1), is mixed in the phosphors.

6. The plasma display panel according to claim 5, wherein the light emission efficiency of the compound is 15% or less with respect to visible light in the range of 450 nm to 780 nm by the irradiation of ultraviolet light at a wavelength of 450 nm or less.

7. The plasma display panel according to claim 5, wherein M1 of the compound is a K element.

8. The plasma display panel according to claim 5, wherein M2 of the compound is a Ca element.

9. The plasma display panel according to claim 6, wherein an amount of the compound represented by the composition formula Cs₍₁₋ₓ₎M1ₓAl0₂ or the compound represented by the composition formula Cs₍₁₋ₓ₎M2ₓAl₍₁₊ₓ₎O₍₂₊₂ₓ₎ in the phosphors is 0.1% or more and 10% or less.

10. The plasma display panel according to claim 5, wherein the compound represented by the composition formula Cs₍₁₋ₓ₎M1ₓAl0₂ (where M1 is the I group element, 0≦x<1) or the compound represented by the composition formula Cs₍₁₋ₓ₎M2ₓAl₍₁₊ₓ₎O₍₂₊₂ₓ₎ (where M2 is the II group element, 0≦x<1) is prepared as a form of powder with an average particle diameter of 0.1 μm or more and 50 μm or less.

11. A plasma display panel comprising:
a front panel in which X electrodes and Y electrodes are formed opposite to each other, a first dielectric layer is formed covering the X and Y electrodes, and a protective layer is formed covering the first dielectric layer;
a rear panel in which address electrodes are formed in a direction perpendicular to the X and Y electrodes, a second dielectric layer is formed covering the address electrodes, barrier ribs are formed on the second dielectric layer so that each of the address electrodes is disposed between the barrier ribs, and phosphors are formed in areas formed by the barrier ribs and the second dielectric layer; and
discharge spaces formed by the protective layer, the phosphors, and the barrier ribs by combing the front panel with the rear panel,
wherein a surface of the barrier rib is formed by a compound represented by the composition formula Cs₍₁₋ₓ₎M1ₓAl0₂ (where M1 is the I group element, 0≦x<1) or by a compound represented by the composition formula Cs₍₁₋ₓ₎M2ₓAl₍₁₊ₓ₎O₍₂₊₂ₓ₎ (where M2 is the II group element, 0≦x<1).

12. The plasma display panel according to claim 11, wherein the weight of the compound represented by the composition formula Cs₍₁₋ₓ₎M1ₓAl0₂ (where M1 is the I group element, 0≦x<1) or the compound represented by the composition formula Cs₍₁₋ₓ₎M2ₓAl₍₁₊ₓ₎O₍₂₊₂ₓ₎ (where M2 is the II group element, 0≦x<1), which constitutes the surface of the barrier rib, is 0.1 mg or more and 1000 mg or less per 100 cm² of the panel area.
